(19) United States
(12) Patent Application Publication
(10) Pub. No.: US 2004/0027359 A1
(43) Pub. Date: Feb. 12, 2004

(54) System and method for generating movie loop display from medical image data

(76) Inventors: Shmuel Aharon, West Windsor, NJ (US); Jeffrey M. Bundy, West Chester, PA (US)

Correspondence Address: Siemens Corporation, Intellectual Property Department, 170 Wood Avenue South, Iselin, NJ, 08830, US

(21) Appl. No.: 10/370,347

(22) Filed: Feb. 19, 2003

Related U.S. Application Data
(60) Provisional application No. 60/358,070, filed on Feb. 19, 2002.
(60) Provisional application No. 60/358,069, filed on Feb. 19, 2002.

(51) Int. Cl. G09G 5/00

(52) U.S. Cl. 345/619

(57) ABSTRACT

A system and method for generating a sequential display of medical image data, such as magnetic resonance (MR) image data, computerized tomography (CT) image data, ultrasound image data, etc. are provided. The method includes the steps of acquiring a plurality of medical image data, each data including an image and associated header information; sorting each of the plurality of medical image data into a plurality of groups based on at least one common attribute identified in the associated header information; and sequentially displaying at least one group of images in a continuous movie loop. Additionally, the method provides for generating multiple images in a single movie loop allowing for comparison between data sets having different properties.

### PRIORITY

This application claims priority to an application entitled “SMART MOVIE GENERATION BASED ON USER DEFINED SORTING GROUPS” filed in the United States Patent and Trademark Office on Feb. 19, 2002 and assigned Serial No. 60/358,070, and to an application entitled “SPATIO-TEMPORAL MATCHING OF IMAGE DATA IN MULTIPLE MOVIE LOOP DISPLAY” filed in the United States Patent and Trademark Office on Feb. 19, 2002 and assigned Serial No. 60/358,069, the contents of which are hereby incorporated by reference.

### BACKGROUND OF THE INVENTION

1. Field of the Invention

The present invention relates generally to computer imaging systems, and more particularly, to a system and method for generating a sequential display of multiple images in a movie (cine) loop from medical image data, such as magnetic resonance (MR) image data, computerized tomography (CT) image data, ultrasound image data, etc.

2. Description of the Related Art

Rapid display of medical image data in a movie (cine) loop is a useful and broadly used tool in medical diagnostics and evaluation. A cine or movie loop is the rapid sequential display of a set of images. It is used, for example, to rapidly display a set of images acquired on successive time intervals to animate the motion of an imaged anatomy. Another usage is to rapidly display images in successive positions parallel to a given orientation, for example, display successive parallel images starting at the head of a person going down towards his legs.

MR CINE data is a set of MR (magnetic resonance) images acquired at successive time intervals to show changes of a particular anatomy structure over time. In the area of cardiology, for example, diagnosis and patient monitoring cannot effectively be done without it. The MR Cine images are used, for example, to visualize the anatomy of the heart over time, e.g., how the heart is contracting during systole and diastole, the changes in the thickness of the heart wall and so on. This information is useful to indicate different heart problems.

Simultaneous display of multiple images in a movie sequence is a powerful tool that allows a user, e.g., a physician or radiology technician, to compare different image data in order to achieve better evaluation. However, conventional imaging systems require manual arrangement of images, so that the images can be run in the simultaneous movie loops. This manual arrangement process is cumbersome and reduces the physician/technician efficiency.

In many clinical cases, one type of medical image data may be acquired more densely than another, hence, has more images. For example, this is very likely in cases such as the acquisition and handling of MR 3D viability data. MR viability image data is acquired some time after an injection of a contrast agent into a patient blood. The MR viability images are acquired after allowing enough time for the contrast agent to diffuse into the patient tissue. MR 3D viability will be acquired in conjunction with MR CINE data, but will be acquired at different, and/or more slice positions. A similar scenario could be described for MR perfusion data, which are acquired a short time after the injection of a contrast agent to visualize how the contrast agent is moving in the blood. Because of its coverage limitation, the MR perfusion data will probably always have less slice positions than the MR CINE or viability data. It may also be the case that the images will be acquired in different orientations and/or time instances. Displaying these multiple data sets side by side in a movie loop for comparison is an important step in clinical evaluation. For accurate comparison, the movie should display the images from each data type in a way that matches their 3D locations, orientations and time instances.

Therefore, a need exists for techniques for rapidly generating a sequential display of images from medical image data and for generating a display of multiple images in a movie loop allowing for fast and accurate comparison of data sets.

### SUMMARY OF THE INVENTION

A system and method for generating a sequential display of multiple images in a movie (cine) loop from medical image data, such as magnetic resonance (MR) image data, computerized tomography (CT) image data, ultrasound image data, etc. are provided. The systems and methods will automatically create movie loops of images based on image sorting into user-definable groups, enabling the user to quickly review the medical image data. Furthermore, the systems and methods of the present invention will generate displays of multiple images in a movie loop in a way that allows fast and accurate clinical comparison between data sets that have different properties, such as density, orientation, and/or acquisition time.

According to an aspect of the present invention, a method for generating a sequential display of medical image data is provided. The method includes the steps of acquiring a plurality of medical image data, each data including an image and associated header information; sorting each of the plurality of medical image data into a plurality of groups based on at least one common attribute identified in the associated header information; and sequentially displaying at least one group of images in a continuous movie loop.

In another aspect, the method further includes the steps of selecting at least two groups of medical image data; and sequentially displaying the two groups of images within a predetermined distance of each other on a display.

In a further aspect, the image and the associated header information are formatted in a single file, such as the DICOM file format or are formatted in separate files.

According to another aspect of the present invention, the method further includes the step of matching images from each group to be displayed simultaneously, wherein the matching step further comprises determining if a common attribute of each image from the plurality of groups are within a predetermined threshold. If the images are outside the predetermined threshold, the method displays at least one image representing one group and displays a blank image representing the other group.

In a further aspect, the matching step further comprises interpolating at least two images to a property point, wherein the property point is a specific time, position or orientation.

According to another aspect of the present invention, a system for generating a sequential display of medical image data includes an input device for acquiring a plurality of medical image data, each data including an image and associated header information; a processor for sorting each of the plurality of medical image data into a plurality of groups based on at least one common attribute identified in the associated header information; and a display device for sequentially displaying at least one group of images in a continuous movie loop. The processor is further adapted for selecting at least two groups of medical image data and sequentially displaying the two groups of images within a predetermined distance of each other on the display device. Furthermore, the input device may be a scanning device for acquiring image of anatomy structures.

According to yet another aspect of the present invention, a program storage device readable by a machine, tangibly embodying a program of instructions executable by the machine to perform the method steps for generating a sequential display of medical image data is provided, the method steps including acquiring a plurality of medical image data, each data including an image and associated header information; sorting each of the plurality of medical image data into a plurality of groups based on at least one common attribute identified in the associated header information; and sequentially displaying at least one group of images in a continuous movie loop.

### BRIEF DESCRIPTION OF THE DRAWINGS

The above and other aspects, features, and advantages of the present invention will become more apparent in light of the following detailed description when taken in conjunction with the accompanying drawings in which:

FIG. 1 is a block diagram of an exemplary system for generating a sequential display of multiple images in a movie (cine) loop from medical image data in accordance with the present invention;

FIG. 2 is a flowchart illustrating a method for generating a sequential display of multiple images in a movie (cine) loop from medical image data according to an embodiment of the present invention;

FIG. 3 is diagram illustrating a structure of medical image data; and

FIG. 4 is a flowchart illustrating a method for generating a sequential display of multiple images in a movie (cine) loop from medical image data according to another embodiment of the present invention

### DETAILED DESCRIPTION OF PREFERRED EMBODIMENTS

Preferred embodiments of the present invention will be described hereinbelow with reference to the accompanying drawings. In the following description, well-known functions or constructions are not described in detail to avoid obscuring the invention in unnecessary detail.

A system and method for generating a sequential display of multiple images in a movie (cine) loop from medical image data, such as magnetic resonance (MR) image data, computerized tomography (CT) image data, ultrasound image data, etc. are provided. In one embodiment, movie loops of images based on image sorting into user-definable groups will be created enabling the user to quickly review the medical image data. In a further embodiment, displays of multiple images in a single movie loop will be generated in a way that allows fast and accurate clinical comparison between data sets that have different properties, such as density, orientation, and/or acquisition time.

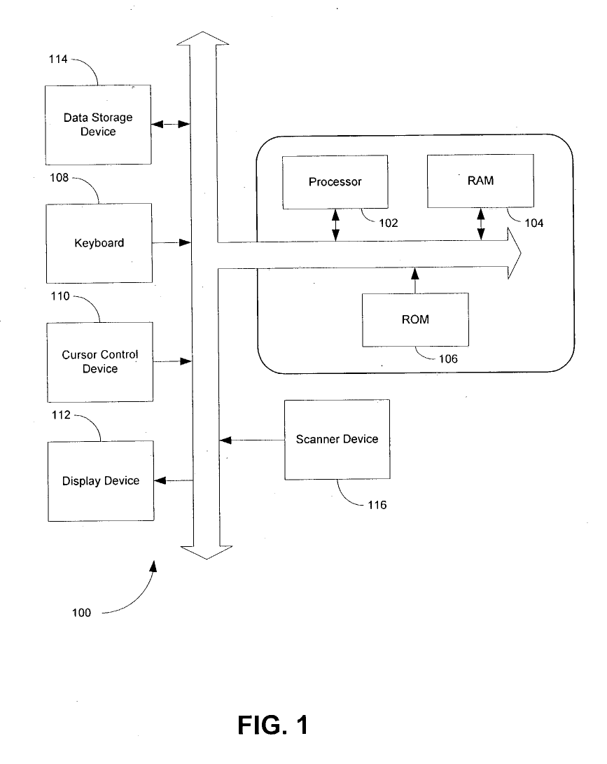

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture such as that shown in FIG. 1. Preferably, the machine 100 is implemented on a computer platform having hardware such as one or more central processing units (CPU) 102, a random access memory (RAM) 104, a read only memory (ROM) 106 and input/output (I/O) interface(s) such as keyboard 108, cursor control device (e.g., a mouse or joystick) 110 and display device 112. The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device 114 and a printing device. Furthermore, a scanner device 116, for example an X-ray machine or MRI (magnetic resonance imaging) machine, may be coupled to the machine 100 for collecting two-dimensional (2D) medical image data.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

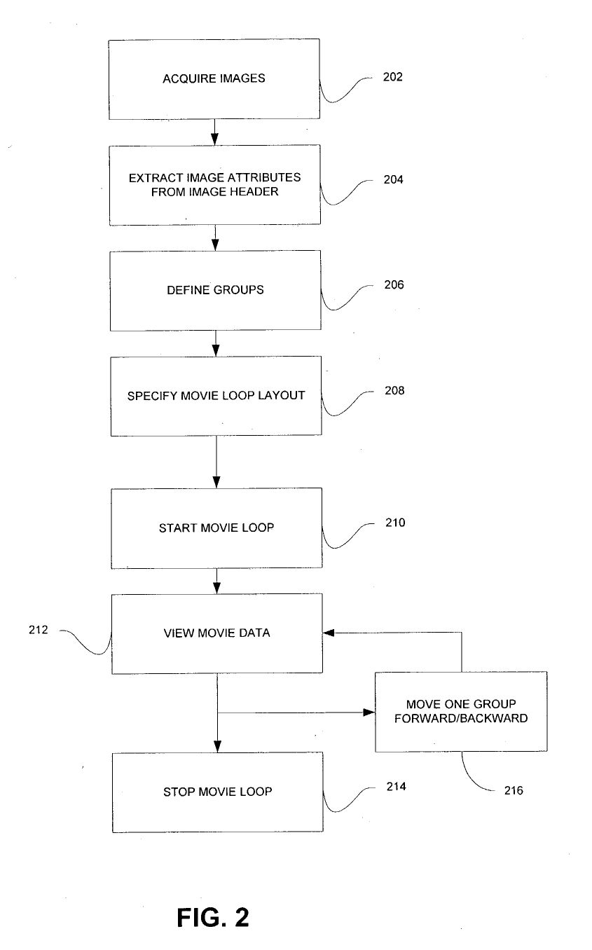

Referring to FIG. 2, a method for generating a sequential display of medical image data will be described in conjunction with FIG. 1. In step 202, a user acquires medical image data. The data can be any medical images that the user wants to visualize, such as MR images, CT images or Ultrasound images. It is to be appreciated that a series of images may be collected and complied by a machine external to system 100. The series of image may then be stored in the system in RAM 104 or the storage device 114, e.g., a hard disk, or may be stored on a removable storage device to be loaded onto the system 100 at a later time. Alternatively, a scanner device 116 may be coupled to the system 100 for generating two-dimensional (2D) images and storing the 2D images in one the system's 100 memories. The scanner device 100 may be a CT machine, MRI machine or any device known in the art for generating 2D slice images of a human body.

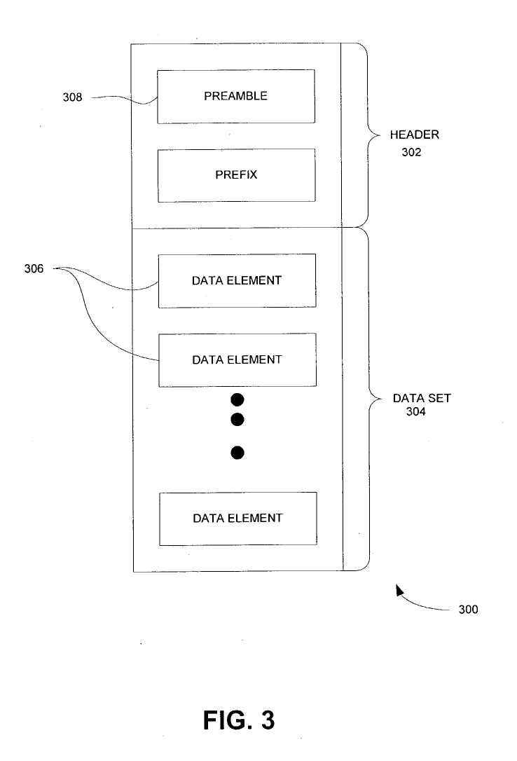

Preferably, the medical image data is stored in a file format that includes an image and various attributes of the image. One such file format is the DICOM (Digital Communications in Medicine) file format as illustrated in FIG. 3. A structure of a DICOM file 300 includes a header 302 for storing image attributes and a data set 304 comprising various data elements 306 for constructing an image. Generally, a preamble 308 of the header 302 will include the image attributes, for example, the time the image was acquired, the patient's name, the image modality used (e.g., CT, MR, etc.), image orientation and position, the type of protocol used for this image (MR cine, MR viability, etc.), and so on. Alternatively, the image data may be stored in one file while the header information is stored in a separate second file, as in the conventional ANALYZE format.

After loading the data, the header information for each image is extracted (step 204). The data is then sorted into different groups, with a user-specified common attribute for each group (such as image orientation, image type, image location, etc. . . . ). For example, in one case, all the images that are parallel to a given plane will form one group; in another case, all the images with the same data type, e.g., MR Cine, will form a different group.

Furthermore, it could also be the case that two common attributes are needed to define a group. For example, a group could be a list of images with the same sequence name and the same protocol name. The images in each group form a series of images. For example, a set of images, with the same attribute(s), that were acquired at different times. An image group is the base set of sequential images that are displayed in a single movie loop.

The user then specifies the different image groups that he would like to view synchronously (step 206). For example, MR Cine images at a specified location. The next step is to define a layout for the movie loop (step 208). That is how many different images will be displayed simultaneously on the display device 112. For example, 1by1 (one image in each movie frame), 1by2 (two different images side by side in each movie frame), 2by2 (four different images side by side in each movie frame), etc.. After defining the movie loop layout, the user starts the movie loop (step 210) and views the movie data (step 216) on display device 112. The method and system will create the movie loops displaying sequential image series as was specified by the user. The user can page through the various image groups and change the groups that are being displayed in the movie loop while the movie is running (step 216). After the review of all data is completed, the user will stop the movie loop manually or it will automatically stop after it is played a predetermined number of repetitions (step 214). Additionally, the movie loop may be stored in a video file format, such as AVI or an animated GIF.

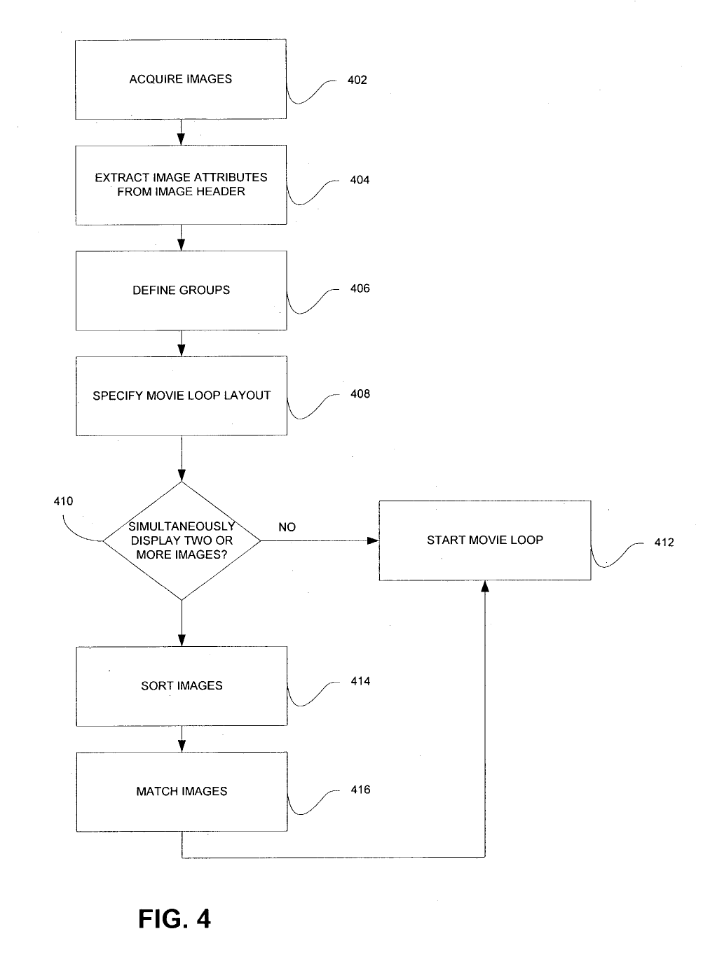

Referring to FIG. 4, another embodiment of a method for generating a sequential display of medical image data is illustrated. Here, the system and method will match image data from different data sets to be displayed simultaneously for comparison purposes.

As described in reference to the above embodiment, the user loads the data (step 402), image attribute are extracted from the header of each data (step 404), and the data is sorted into different groups (step 406).

In step 408, the user specifies the movie display parameters. These parameters include the display layout (for example 1by1 or 2by4), the movie sequence type, and thresholds that will be used to determine images with the same (or close) attributes (properties), as will be described in detail below. The movie sequence type specifies the attribute used to order the images sequence. For example, the movie will show image sequences over time with the same position and orientation. Another movie sequence type may show sequential images over position with the same time and orientation. The user-specified thresholds are used to determine same or close images based on the selected attribute. For example, if the distance between two images is smaller than a specified distance threshold, these two images will be considered to have same position. Similarly, if the time difference between two images is smaller than a specified time interval threshold, these two images will be considered to have the same time. Images having their orientation difference smaller than a specified angle threshold will be considered to have the same orientation.

If the movie loop was set to the simultaneous display of two or more data sets in a single multi-image layout (for example 1by2 or 2by2) in step 410, the method will continue to a data matching algorithm (step 414 and 416) and then with the movie processing (step 412); otherwise, the method continues with regular movie processing (step 412).

The Matching Algorithm

The images from each data set are sorted into different groups based on the specified movie sequence type (step 414). For a sequence of images with the same position and orientation over time, the images are sorted on their 3D positions, orientations and time instances, in that order. For sequences of images with the same time and orientation over position, the images are sorted on their time, orientation and position, in that order. Similarly, for sequences of images with the same position and time over orientation, the images are sorted on their position, time and orientation, in that order. The images are then divided into groups with equal or close image orientation, position and time instance. The order of the images in these groups is based on the movie sequence type. Close image orientations, positions, and or times are based on the specified thresholds (step 416).

The method also provides the option to interpolate images to match the exact image positions, orientations, and/or time instances. An image is interpolated to a specific property point using the two images that define the smallest property interval that includes this specific property point. A property point defines a specific time, position or orientation, based on the image property, desired to be matched. For example, to interpolate an image to a specific time point, the program will locate the two images defining the smallest time interval containing the requested time point. The image at this requested time point can now be interpolated from the two located images using common interpolation methods that are described in the art. The matched image groups are then displayed in the movie loop (step 412).

Images from the same data sets will always be displayed on the same screen location. For example, in a 1by2 layout, all viability images will be on the left side and all CINE images on the right side. Images that cannot be matched will be displayed alone without any image in the corresponding image location from the other data set, e.g., a blank image.

As a result of this matching the movie loop will display side by side images from different data sets but with the same (or close) orientation, position and time instance. This will allow accurate comparison of these data sets for clinical evaluation.

It should be appreciated that matching the time instances of the images is based on the time interval from a specified reference time point (defined as the time of one image in each data set) to the time of an image in the same data set. This is necessary to overcome the fact that each data was acquired at a different time. The default reference time point will be the time of the first image in each data set. However, the user will be able to specify a different time as the reference time in each data set.

### ILLUSTRATIVE EXAMPLE

### MR Data

The following example will be described to illustrate the matching of images according to the present invention.

MR 3D viability may be acquired in conjunction with MR CINE data, but at different and/or more slice positions. Both data sets have the same time intervals and orientations. When the 1by2, 2by2 or 2by4 movie loops are created, the method attempts to match data based on the “closest” slice position rather than matching the slice positions precisely or simply going row to row while building the movie loops. For example assume that the CINE sequence is acquired at slice positions, 10, 20, 30 and 40, but the viability data is acquired at 8, 17, 26, 35 and 44 and both data sets are acquired in the same orientation. When a user steps through a series of movies, the following pairings should result with a user-defined threshold of 4:

TABLE 1

| Grouping | Cine Data | Viability Data |
|---|---|---|
| 1 | 10 | 8 |
| 2 | 20 | 17 |
| 3 | 30 | 26 |
| 4 | None | 35 |
| 5 | 40 | 44 |

Similarly, when using a threshold of 2, the following pairings will result:

TABLE 2

| Grouping | Cine Data | Viability Data |
|---|---|---|
| 1 | 10 | 8 |
| 2 | None | 17 |
| 3 | 20 | None |
| 4 | None | 26 |
| 5 | 30 | None |
| 6 | None | 35 |
| 7 | 40 | None |
| 8 | None | 44 |

In Tables 1 and 2, “None” indicates no image was found within the specified threshold and a blank image is displayed.

Systems and methods for generating sequential displays of medical image data in a movie (cine) loop have been described. Movie loops of images based on image sorting into user-definable groups will be created enabling the user to quickly review the medical image data. Additionally, displays of multiple images in a single movie loop will be generated in a way that allows fast and accurate clinical comparison between data sets that have different properties.

While the invention has been shown and described with reference to certain preferred embodiments thereof, it will be understood by those skilled in the art that various changes in form and detail may be made therein without departing from the spirit and scope of the invention as defined by the appended claims.

What is claimed is:

1. A method for generating a sequential display of medical image data, the method comprising the steps of:
acquiring a plurality of medical image data, each data including an image and associated header information;
sorting each of the plurality of medical image data into a plurality of groups based on at least one common attribute identified in the associated header information; and
sequentially displaying at least one group of images in a continuous movie loop.

2. The method of claim 1, further comprising the steps of:
selecting at least two groups of medical image data; and
sequentially displaying the two groups of images within a predetermined distance of each other on a display.

3. The method of claim 1, wherein the image and the associated header information are formatted in a single file.

4. The method of claim 1, wherein the image and the associated header information are formatted in separate files.

5. The method of claim 1, wherein the medical image data is in a DICOM format.

6. The method of claim 1, further comprising the step of storing the continuous movie loop in a video format file.

7. The method of claim 2, further comprising the step of matching images from each group to be displayed simultaneously.

8. The method of claim 7, wherein the matching step further comprises determining if a common attribute of each image from the plurality of groups are within a predetermined threshold.

9. The method of claim 8, wherein if the images are outside the predetermined threshold, displaying at least one image representing one group and displaying a blank image representing the other group.

10. The method of claim 7, wherein the matching step further comprises interpolating at least two images to a property point.

11. The method of claim 10, wherein the property point is a specific time, position or orientation.

12. A system for generating a sequential display of medical image data comprising:
an input device for acquiring a plurality of medical image data, each data including an image and associated header information;
a processor for sorting each of the plurality of medical image data into a plurality of groups based on at least one common attribute identified in the associated header information; and
a display device for sequentially displaying at least one group of images in a continuous movie loop.

13. The system of claim 12, wherein the processor is further adapted for selecting at least two groups of medical image data and sequentially displaying the two groups of images within a predetermined distance of each other on the display device.

14. The system of claim 13, wherein the processor is further adapted for matching images from each group to be displayed simultaneously.

15. The system of claim 14, wherein the processor is further adapted for determining if a common attribute of each image from the plurality of groups are within a predetermined threshold.

16. The system of claim 15, wherein the input device is a scanning device for acquiring image of anatomy structures.

17. A program storage device readable by a machine, tangibly embodying a program of instructions executable by the machine to perform the method steps for generating a sequential display of medical image data, the method steps comprising:
acquiring a plurality of medical image data, each data including an image and associated header information;
sorting each of the plurality of medical image data into a plurality of groups based on at least one common attribute identified in the associated header information; and
sequentially displaying at least one group of images in a continuous movie loop.

18. The program storage device of claim 17, further comprising the steps of:
selecting at least two groups of medical image data; and
sequentially displaying the two groups of images within a predetermined distance of each other on a display.

19. The program storage device of claim 18, further comprising the step of matching images from each group to be displayed simultaneously.

20. The program storage device of claim 19, wherein the matching step further comprises determining if a common attribute of each image from the plurality of groups are within a predetermined threshold.
